(19) United States
(12) Patent Application Publication
(10) Pub. No.: US 2025/0019308 A1
(43) Pub. Date: Jan. 16, 2025

(54) POWDERY HYDRAULIC COMPOSITION

(71) Applicant: TOKUYAMA CORPORATION, Yamaguchi (JP)

(72) Inventors: Takahiro ONISHI, Yamaguchi (JP); Kohei OMURA, Yamaguchi (JP); Takumi DEGUCHI, Yamaguchi (JP)

(73) Assignee: TOKUYAMA CORPORATION, Yamaguchi (JP)

(21) Appl. No.: 18/712,959

(22) PCT Filed: Nov. 30, 2022
(86) PCT No.: PCT/JP2022/044087

§ 371 Date: May 23, 2024

(30) Foreign Application Priority Data
Dec. 2, 2021 (JP) 2021-196360

(51) Int. Cl. C04B 28/26; C04B 18/08; C04B 18/14; C04B 22/10; C04B 40/00

(52) U.S. Cl. CPC C04B 28/26; C04B 18/088; C04B 18/141; C04B 22/10; C04B 40/0042; C04B 40/0046

(57) ABSTRACT

A powdery hydraulic composition that includes: a powder raw material A having at least one or more selected from fly ash and slag fine powder, and a powder raw material B having at least one or more selected from alkali silicate powder and alkali carbonate powder, and by mixing with water, hardening is possible even at ordinary temperature, and it is not necessary to use alkali solution comprising sodium hydroxide, etc.

### TECHNICAL FIELD

The present invention relates to a powdery hydraulic composition. Specifically, it relates to a powdery hydraulic composition, a hydraulic composition, a method for producing the hydraulic composition, a hydraulic composition hardened body, and a method for producing the hydraulic composition hardened body.

### BACKGROUND ART

The CO₂ emission amount when burning 1 t of cement clinker is said to be about 1.1 t derived from the burning of fuel, and the CO₂ emission amount related to cement concrete is said to represent about 40% of the total CO₂ emission amount in the constructional industry.

As such, in the recent constructional industry, as an effort to realize a low carbon society, the technology development to quickly reduce the CO₂ emission amount when producing concrete or mortar by using a material alternative of Portland cement as a binder of concrete or mortar is promoted.

Under such situation, geopolymer is recently gaining attention as an alternative material of Portland cement. Geopolymer is said to be hardened, for example by not using cement clinker, and using a raw material (active filler) comprising amorphous aluminum silicate as main component and alkali solution (Non-Patent Literature 1).

By using geopolymer as binder of concrete or mortar, large consumption of industrial by-product such as fly ash or slag fine powder is possible, and further it is estimated to be possible to reduce about 75% of CO₂ emission amount as compared to Portland cement. As such, geopolymer is gaining attention as an innovative binder for concrete or mortar for realizing a low carbon-resource recycling society.

For example, Patent Literature 1 discloses a geopolymer composition using blast furnace slag fine powder, fly ash, sewage incineration sludge comprising amorphous aluminum sulfate as active filler, and using water glass (sodium silicate solution) or potassium silicate solution mixed with sodium hydroxide solution or potassium hydroxide solution as alkali active agent.

Further, in Patent Literature 2, a pre-mixed geopolymer composition comprising as powder raw material, blast furnace slag fine powder and fly ash comprising amorphous aluminum sulfate as main component, and obtained by powder mixing fine aggregates and silica fume is made. Patent Literature 2 discloses a method for producing a geopolymer composition comprising obtaining a geopolymer hardened body by mixing the premix geopolymer composition and potassium hydroxide solution or sodium hydroxide solution as alkali source, and ordinary temperature curing is possible.

### CITATION LIST

### Patent Literature

Patent Literature 1: Japanese Patent Laid-Open Publication No. 2008-239446
Patent Literature 2: Japanese Patent Laid-Open Publication No. 2021-066613

### Non-Patent Literature

Non patent Literature 1: Kazuo Ichimiya, and 2 others, “Current situation of geopolymer and future outlook”, Concrete engineering, 2018, Vol. 56, No. 5, P. 410

### SUMMARY OF INVENTION

### Technical Problem

Regarding the geopolymer composition disclosed in the above Patent Literature 1, a hardened body having sufficient strength cannot be obtained unless using an alkali hydroxide solution having a concentration of 5 mass % or more which is designated as deleterious substance as alkali active agent.

Further, for the geopolymer composition disclosed in Patent Literature 2, since potassium hydroxide or sodium hydroxide aqueous solution having a concentration of 5 mass % or more which is designated as deleterious substance is similarly used, the manufacturing operation has a high risk. Further, an accurate preparation of alkali solution is necessary at the production site, and it can be estimated that the variation of properties of the geopolymer composition would be larger since the preparation operation is difficult.

Specifically, no powdery hydraulic composition being practicable, that do not at all require a preparation operation of strong alkali solution having high risk at the production site, and which hardening is possible even at ordinary temperature by mixing with pure water, similarly as cement being a commonly used material is disclosed yet.

Specifically, development of a hydraulic composition which hardening is possible at ordinary temperature similarly as the above-mentioned geopolymer, as binder of concrete or mortar that can be an alternative of cement, and that ameliorates workability or safety when manufacturing concrete is awaited.

The present invention has been made in view of the above, and it is intended to provide a powdery hydraulic composition which hardening is possible even at ordinary temperature by merely mixing with water, in which alkali source and silica source in the alkali active agent are powdered.

### Solution to Problem

The present inventors made a keen study to solve the above-mentioned object, and as a result, they found out that by making a powdery hydraulic composition comprising a powder raw material A comprising fly ash and/or slag fine powder and a powder raw material B comprising alkali silicate powder and/or alkali carbonate powder, hardening is possible even at ordinary temperature by merely mixing with water. The present invention has been thus completed.

Specifically, the first embodiment of the present invention is a powdery hydraulic composition characterized by comprising a powder raw material A comprising at least one or more selected from fly ash and slag fine powder, and a powder raw material B comprising at least one or more selected from alkali silicate powder and alkali carbonate powder.

The second embodiment of the present invention is a hydraulic composition comprising a powder raw material A comprising at least one or more selected from fly ash and slag fine powder, a powder raw material B comprising at least one or more selected from alkali silicate powder and alkali carbonate powder, and water.

The third embodiment of the present invention is a method for producing a hydraulic composition, comprising mixing a powder raw material A comprising at least one or more selected from fly ash and slag fine powder, and a powder raw material B comprising at least one or more selected from alkali silicate powder and alkali carbonate powder with water.

The fourth embodiment of the present invention is a hydraulic composition hardened body which is a hardened body of the hydraulic composition.

The fifth embodiment of the present invention is a method for producing a hydraulic composition hardened body comprising curing the hydraulic composition at a temperature range of 5° C. to 90° C. It is preferable to cure at ordinary temperature (5° C. to 35° C.).

In the first to fifth embodiments of the present invention, it is preferable that the powder material A comprises fly ash and slag fine powder, and the powder material B comprises alkali silicate powder and alkali carbonate powder.

In the first to fifth embodiments of the present invention, it is preferable that alkali silicate powder is sodium silicate powder. Further, it is preferable that alkali carbonate powder is sodium carbonate powder.

### Advantageous Effects of Invention

According to the present invention, it is possible to provide a powdery hydraulic composition which hardening is possible even at ordinary temperature by mixing with water. Since no alkali solution comprising sodium hydroxide or potassium hydroxide having a concentration of 5 mass % or more, being referred in Poisonous and Deleterious Substances Control Law, the safety of the production operation of hydraulic composition or hydraulic composition hardened body which is a hardened body thereof can be ameliorated. Further, since by merely mixing the powdery hydraulic composition with water, hardening at ordinary temperature becomes possible, accurate preparation of alkali solution at the production site becomes unnecessary, and the variability of properties of the obtained hydraulic composition hardened body can be reduced. Further, a hydraulic composition (geopolymer composition) being excellent in subsequent strength development can be provided. Therefore, it is possible to provide a powdery hydraulic composition that can be an alternative of cement, offering more versatility, which can be commonly and suitably used in the construction industry.

### DESCRIPTION OF EMBODIMENTS

In the following the embodiments of the present invention will be explained in detail, while the present invention shall not be limited to these embodiments. Further, “part” or “%” herein mentioned refers to mass standard, unless otherwise defined.

### <Powdery Hydraulic Composition>

The powdery composition of the present invention comprises a powder raw material A comprising at least one or more selected from fly ash and slag fine powder, and a powder raw material B comprising at least one or more selected from alkali silicate powder and alkali carbonate powder. The powdery hydraulic composition of the present invention may be referred to as geopolymer composition, and the hydraulic composition hardened body being a hardened body of the hydraulic composition comprising the powdery hydraulic composition and water may be referred to as geopolymer hardened body.

### (Powder Raw Material A)

Powder raw material A (active filler (raw material comprising amorphous aluminum silicate as main component)) comprises at least one or more selected from fly ash and slag fine powder.

### (Fly Ash)

Fly ash comprised in the powder raw material A is a fine ash collected from discharged gas with an ash collector, among coal ash obtained as by-product when burning coal in coal-burning plant, etc. It comprises SiO₂, Al₂O₃ as main components, and are standardized into Types I to IV based on particle size or flow value, in JIS A 6201. The standard of fly ash is not particularly limited, but type I and type II which particle size is fine, and have a rich reactivity are preferable.

### (Slag Fine Powder)

Slag fine powder comprised in the powder raw material A is formed when generating pig iron, and comprises CaO, SiO₂, Al₂O₃, MgO as main components. Examples of slag fine powder include, for example, those comprising 20 mass % or more and 60 mass % or less of calcium in calcium oxide (CaO) equivalent can be exemplified. When mixing the powdery hydraulic composition of the present invention with water to make a hydraulic composition, such slag fine powder reacts with alkali components or silica components in liquid phase, and a hardened body having higher durability can be obtained. Further, the types of slag are not particular limited, and can be any of blast furnace slag or steel slag, and blast furnace slag is preferable from the viewpoint of reactivity. Particularly, it is preferable to use those standardized as JIS A 6206.

It is sufficient that the powder raw material A comprises at least one or more selected from fly ash and slag fine powder, while it is preferable that fly ash and slag fine powder are comprised.

In case the powder raw material A comprises fly ash and slag fine powder, the content rate of fly ash with respect to the total amount of fly ash and slag fine powder is preferably 50 to 90 mass %, and more preferably 60 to 85 mass %. When it is 50 mass % or more, when it is mixed with water to make a hydraulic composition, it is possible to maintain good flowability, and sufficient workability can be easily obtained, it is also preferable from the viewpoint of expanding efficient use of fly ash. Further, when it is 90 mass % or less, a good strength development of the hydraulic composition hardened body can be obtained in early material age.

Further, the content rate of the total amount of fly ash and slag fine powder in the powder raw material A is preferably 80 mass % or more, more preferably 90 mass % or more, further more preferably 95 mass % or more, and particularly preferably to be substantially 100 mass %.

### (Powder Raw Material B)

Powder raw material B (alkali active agent) comprises at least one or more selected from alkali silicate powder and alkali carbonate powder.

### (Alkali Silicate Powder)

Examples of alkali silicate powder comprised in the powder raw material B include sodium silicate powder (SiO₂/NaO₂ molar ratio: approximately 1.95 to 3.4) and sodium metasilicate powder (one type, two types), potassium silicate powder, potassium metasilicate powder, lithium silicate powder, etc. Since it is excellent in strength development and durability, and it is a powder material having relatively a low price, sodium silicate powder (SiO₂/NaO₂ molar ratio: approximately 1.950 to 2.2, H₂O=about 20 mass %) is preferable.

### (Alkali Carbonate Powder)

Examples of alkali carbonate powder comprised in the powder raw material B include sodium carbonate (Na₂CO₃), potassium carbonate (K₂CO₃), lithium carbonate (Li₂CO₃), etc. Sodium carbonate powder having a relatively low price and showing high reactivity to slag fine power is preferable.

It is sufficient that the powder raw material B comprises at least one or more selected from alkali silicate powder and alkali carbonate powder, while it is preferable that alkali silicate powder and alkali carbonate powder are comprised.

In case the powder raw material B comprises alkali silicate powder and alkali carbonate powder, the molar ratio of silicon (Si) comprised in alkali silicate powder and alkali carbonate powder comprised in powder raw material B with respect to alkali metal element (AL) Si/AL is preferably 0.05 to 0.85. By setting Si/AL to 0.05 or more, contraction of the hydraulic composition hardened body can be reduced, and by setting Si/AL to 0.85 or less, flowability so that the hydraulic composition can be easily used in the fieldwork can be secured. From the above, it is more preferable that Si/AL is 0.2 to 0.75.

Further, the content rate of the total amount of alkali silicate powder and alkali carbonate powder in the powder raw material B is preferably 80 mass % or more, more preferably 90 mass % or more, further more preferably 95 mass % or more, and particularly preferably to be substantially 100 mass %.

Further, it is preferable that the powder raw material B does not comprise alkali hydroxide such as sodium hydroxide, etc. As such, safety of the operation is enhanced.

It is particularly preferable that in the powdery hydraulic composition of the present invention, the powder raw material A comprises fly ash and slag fine powder, and the powder raw material B comprises alkali silicate powder and alkali carbonate powder. As such, the calcium content would be lower as compared with hardened cement, or a polymer having a double chain structure would be formed in the hydraulic composition hardened body, and thus acid resistance or durability is improved.

In the powdery hydraulic composition of the present invention, various admixtures, mixture materials can be mixed in addition to the above, within a range that it does not impair the function effect of the present invention. For example, publicly known materials used in concrete, such as a fluidizer, shrinkage reducer, antirust agent, waterproof material, retarder, antifoam agent, dust reducer, colorant, calcium carbonate powder, etc. can be exemplified. In such case, the content rate of the total amount of fly ash and slag fine powder, and alkali silicate powder and alkali carbonate powder in the powdery hydraulic composition of the present invention is preferably 80 mass % or more, and preferably 90 mass % or more.

In the powdery hydraulic composition of the present invention, various aggregates can be further added in addition to the above, according to the application of the hydraulic composition. For example, publicly known aggregates used in concrete such as lightweight aggregate, normal aggregate, heavy weight aggregate, limestone aggregate, slag aggregate, silica sand, etc. can be exemplified.

### <Method for Producing Powdery Hydraulic Composition>

Production of the powdery hydraulic composition of the present invention comprises a powder mixing step of mixing the powder raw material A comprising at least one or more selected from fly ash and slag fine powder, and the powder raw material B comprising at least one or more selected from alkali silicate powder and alkali carbonate powder as powder. Further, after the powder mixing step, a second powder mixing step of mixing various admixtures such as powdery fluidizer or retarder, etc., and aggregates can be provided.

The powdery hydraulic composition of the present invention can be used as a premix composition. By making a premix composition, by merely mixing the premix composition with water, the following hydraulic composition can be produced, and by curing it, it becomes possible to make a hardened body. As such, the hardened body of the present invention utilizing a premix composition has a higher compression strength and lower unevenness of strength, as compared with for example a hardened body produced by using the powder raw material B as a solution (alkali solution).

### <Hydraulic Composition>

The hydraulic composition of the present invention is a composition comprising a powder raw material A comprising at least one or more selected from fly ash and slag fine powder, and a powder raw material B comprising at least one or more selected from alkali silicate powder and alkali carbonate powder, and water, and for example, it is a composition comprising the above-mentioned powdery hydraulic composition of the present invention and water. Further, the powdery hydraulic composition of the present embodiment may be present as a part of constituting raw material when producing mortar or concrete, etc.

The molar ratio of alkali metal element (AL) comprised in the powder raw material B with respect to water (W) AL/W is preferably 0.05 to 0.3. By setting AL/W to 0.05 or more, the compression strength of the hydraulic composition can be secured even at ordinary temperature, and by setting AL/W to 0.3 or less, flowability so that the hydraulic composition can be easily used in the fieldwork can be secured. From the above viewpoint, it is more preferable that AL/W is 0.05 to 0.18, and further preferable to be 0.08 to 0.12.

### <Method for Producing Hydraulic Composition>

The hydraulic composition of the present invention can be produced by mixing a predetermined amount of the above-mentioned powder raw material A and powder raw material B, and water, and according to need various admixture materials, aggregates at the same time or sequentially, and by appropriately kneading the mixture with a kneading apparatus. The kneading apparatus is not particularly limited, and for example, bi-axial forced mixer used for kneading concrete, etc. can be exemplified.

The method for producing a hydraulic composition comprises, for example a powder mixing step of powder mixing a powder raw material A, a powder raw material B and aggregates, or powder mixing the powdery hydraulic composition of the present invention and aggregates, and a kneading step of kneading by introducing water after the powder mixing step. Further, in the kneading step, admixtures or mixture materials such as fluidizer or retarder, etc. can be mixed at the same time and kneaded, or a second kneading step of mixing and kneading admixtures or mixture materials such as fluidizer or retarder, etc. can be provided after the kneading step.

### <Method for Producing Hydraulic Composition Hardened Body>

By curing the hydraulic composition at a temperature range of 5° C. to 90° C. after the kneading step or second kneading step, a hydraulic composition hardened body which is a hardened body of the hydraulic composition can be obtained. Particularly, with the hydraulic composition of the present invention, a hydraulic composition hardened body being excellent in compression strength can be obtained by curing at ordinary temperature of 5° C. to 35° C. The other curing conditions are not particularly limited, and can be commonly used curing conditions. For example, steam curing, sealed curing, atmospheric curing, water curing, etc. are used.

According to the method for producing the hydraulic composition or hydraulic composition hardened body of the present invention, since preparation of alkali solution at the production site at the time of preparation is not necessary, workability is excellent as compared with publicly known geopolymers. Further, since deleterious substances are not used in raw materials, the safety of operation is excellent as compared with publicly known geopolymer compositions. Further, as compared with publicly known geopolymers, since sodium carbonate having a price lower than alkali hydroxide is used, it is excellent in the point of cost. Further, the compression strength is good as compared with publicly known geopolymer hardened body at ordinary temperature curing. Therefore, as compared with publicly known geopolymers, it has advantages of having excellent workability, safety of operation, cost, and strength development of the hardened material. Thus, the hydraulic composition hardened body obtained by using the powdery hydraulic composition of the present invention can be used in various applications in place of cement composition or concrete composition.

### EXAMPLES

In the following, the present invention will be explained in further details, by referring to specific examples. However, the present invention is not limited to the following examples. Unless the features of the present invention are not largely impaired, various deformed examples or applications are also encompassed in the present invention.

### (Raw Material)

Powder raw material A (fly ash, slag fine powder)
(1) fly ash: Type II fly ash (in conformity to JIS A 6201)
(2) slag fine powder: furnace slag fine powder 4000 (in conformity to JIS A 6206)

Powder raw material B (alkali silicate powder, alkali carbonate powder)
(3) powder sodium silicate: sodium silicate powder (SiO₂/Na₂O molar ratio=1.98, H₂O=about 20 mass %, manufactured by Tokuyama Corporation)
(4) soda ash: sodium carbonate powder (manufactured by Tokuyama Corporation)

### Other Raw Materials

(5) aggregates: fine aggregates (JIS standard sand)
(6) water: ion exchange water
(7) sodium hydroxide: high grade reagent (manufactured by FUJIFILM Wako Pure Chemical Corporation)
(8) water glass No. 1: sodium silicate solution (No. 1) (SiO₂: Na₂O molar ratio=2.01, manufactured by KISHIDA CHEMICAL CO., LTD.)

### Examples 1 to 6

### [Preparation of Powdery Hydraulic Composition]

Fly ash and slag fine powder were weighed as powder raw material (A), powder sodium silicate and soda ash were weighed as powder raw material (B) according to the recipe of the following Table 1, stirred for 3 min in a polyethylene bag to prepare a powdery hydraulic composition having a uniform dispersion state.

TABLE 1

| | | | ALW | | | | | | | | |
|---|---|---|---|---|---|---|---|---|---|---|---|
| | | | | | | water glass | | | | | |
| | P | | | | powder | No. 1 | | JIS | | | (AL + |
| | | slag fine | | NaOH35% | sodium | diluted | | standard | AL/W | Si/AL | W)/P |
| | fly ash | powder | soda ash | solution | silicate | 1.5-fold | water | sand | (molar | (molar | (volume |
| | (g) | (g) | (g) | (g) | (g) | (g) | (g) | (g) | ratio) | ratio) | ratio) |
| Comparative | 315 | 135 | — | 44.0 | — | 189 | 46.0 | 1350 | 0.10 | 0.71 | 1.14 |
| Example 1 | | | | | | | | | | | |
| Example 1 | 315 | 135 | 16.9 | — | 89.3 | — | 180 | 1350 | 0.10 | 0.71 | 1.14 |
| Example 2 | 315 | 135 | 16.4 | — | 87.0 | — | 176 | 1350 | 0.10 | 0.71 | 1.11 |
| Example 3 | 315 | 135 | 20.4 | — | 90.5 | — | 176 | 1350 | 0.11 | 0.67 | 1.14 |
| Example 4 | 315 | 135 | 51.7 | — | 26.8 | — | 199 | 1350 | 0.11 | 0.20 | 1.15 |
| Example 5 | 289 | 161 | 50.9 | — | 26.5 | — | 196 | 1350 | 0.11 | 0.20 | 1.15 |
| Example 6 | 241 | 209 | 49.6 | — | 25.7 | — | 191 | 1350 | 0.11 | 0.20 | 1.15 |

*AL/W: molar ratio of alkali metal element (AL) contained in soda ash, powder sodium silicate or sodium hydroxide, water glass No. 1 to water (W)
*Si/AL: molar ratio of silicon (Si) contained in soda ash or powder sodium silicate or sodium hydroxide, water glass No. 1 to alkali metal element (AL)
*(AL+W)/P: volume ratio of the solution in which soda ash, powder sodium silicate or sodium hydroxide, water glass No. 1 are mixed with water to fly ash, slag fine powder

### [Knead Mixing of Mortar Using Hydraulic Composition]

The above-mentioned powdery hydraulic composition and a predetermined amount of water were put in a Hobart mixer and stirred for 1 min., 1350 g of aggregates were put and knead mixed for 30 sec., and by scraping off for 15 sec., the mixture was further knead mixed for 2 min. to obtain a hydraulic composition knead mixed uniformly as a mortar. The 15-stroke mortar flow value and the compressive strength of the obtained mortar were measured. The results are shown in Tables 2 and 3.

### Comparative Example 1

Comparative example 1 is a conventional geopolymer composition using an alkali active agent consisting of sodium hydroxide solution and water glass No. 1. AL/W (molar ratio), Si/AL (molar ratio) and ALW/P (volume ratio) contributing to the compression strength and 15-stroke mortar flow value (flowability) were in conformity with Example 1.

### [Preparation of Alkali Active Agent and Powder Raw Material A]

First, water, sodium hydroxide and water glass No. 1 were weighed according to the recipe of Table 1, to prepare a mixed solution, and an alkali active agent was obtained. Next, fly ash and slag fine powder were weighed according to the recipe of Table 1, put in a polyethylene bag and stirred for 3 min. to prepare a powder raw material A having a uniform dispersion state.

### [Knead Mixing of Geopolymer Composition Mortar Using Alkali Active Agent and Powder Raw Material A]

The above-mentioned powder raw material A and an alkali active agent were put in a Hobart mixer and stirred for 1 min., 1350 g of aggregates were put and knead mixed for 30 sec., and by scraping off for 15 sec., the mixture was further knead mixed for 2 min. to obtain a geopolymer composition mortar knead mixed uniformly. The 15-stroke mortar flow value and the compressive strength of the obtained mortar were measured. The results are shown in Tables 2 and 3.

### [Mortar Flow Test]

In conformity to mortar flow test described in JIS A 5201, 15-stroke mortar flow value of Examples 1 to 6 and Comparative example 1 after being subjected to 15 times of falling motions immediately after preparation was measured. The results are shown in Table 2.

TABLE 2

| | 15-stroke mortar flow value (mm) |
|---|---|
| Comparative Example 1 | 194.1 |
| Example 1 | 184.5 |
| Example 2 | 176.9 |
| Example 3 | 168.3 |
| Example 4 | 204.8 |
| Example 5 | 191.3 |
| Example 6 | 167.2 |

(n = 3)

### [Compressive Strength Test]

The mortar of Examples 1 to 6 and Comparative example 1 were enclosed in a container having a diameter (φ) of 50 mm×100 mm, and seal curing was performed at 20° C., until a predetermined material age (day 1, day 7, and day 28).

Compressive strength test was performed to mortar cured until a predetermined material age (day 1, day 7, and day 28), in conformity with the compressive strength test law described in JIS A 1108, to measure the compressive strength. The results are shown in Table 3.

TABLE 3

| | compressive strength test (N/mm²) | | |
|---|---|---|---|
| | day 1 | day 7 | day 28 |
| Comparative Example 1 | 12.2 | 36.0 | 58.1 |
| Example 1 | 12.6 | 50.1 | 66.8 |
| Example 2 | 13.4 | 50.3 | 69.6 |
| Example 3 | 13.87 | 48.67 | 66.73 |
| Example 4 | 5.13 | 33.17 | 61.10 |
| Example 5 | 2.3 | 41.9 | 62.6 |
| Example 6 | 5.8 | 54.5 | 74.7 |

(n = 3)

As shown in Table 2, in Examples 1 to 6, as compared with Comparative Example 1, 15-stroke mortar flow value tends to be slightly low, while it is thought that there is almost no influence on workability. Further, as shown in Table 3, in Examples 1 to 6, as compared with Comparative Example 1, it can be understood that a high compressive strength can be obtained particularly after a material age of day 7 or after.

1. A powdery hydraulic composition comprising:
a powder raw material A comprising at least one or more selected from fly ash and slag fine powder, and
a powder raw material B comprising at least one or more selected from alkali silicate powder and alkali carbonate powder.

2. The powdery hydraulic composition according to claim 1, wherein the powder raw material A comprises fly ash and slag fine powder, and
the powder raw material B comprises alkali silicate powder and alkali carbonate powder.

3. The powdery hydraulic composition according to claim 1, wherein the alkali silicate powder is sodium silicate powder.

4. The powdery hydraulic composition according to claim 1, wherein the alkali carbonate powder is sodium carbonate powder.

5. A hydraulic composition comprising:
a powder raw material A comprising at least one or more selected from fly ash and slag fine powder,
a powder raw material B comprising at least one or more selected from alkali silicate powder and alkali carbonate powder, and
water.

6. The hydraulic composition according to claim 5, wherein the powder raw material A comprises fly ash and slag fine powder, and
the powder raw material B comprises alkali silicate powder and alkali carbonate powder.

7. A method for producing a hydraulic composition comprising mixing:
a powder raw material A comprising at least one or more selected from fly ash and slag fine powder,
a powder raw material B comprising at least one or more selected from alkali silicate powder and alkali carbonate powder, and
water.

8. The method for producing a hydraulic composition according to claim 7, wherein water is mixed after mixing the powder raw material A and the powder raw material B.

9. The method for producing a hydraulic composition according to claim 7, wherein the powder raw material A comprises fly ash and slag fine powder, and the powder raw material B comprises alkali silicate powder and alkali carbonate powder.

10. A hydraulic composition hardened body which is a hardened body of the hydraulic composition according to claim 5.

11. A method for producing a hydraulic composition hardened body comprising curing the hydraulic composition according to claim 5 at a temperature range of 5° C. to 90° C.

12. The method for producing a hydraulic composition hardened body according to claim 11, wherein curing is performed at 5° C. to 35° C.
